(19) United States
(12) Patent Application Publication
(10) Pub. No.: US 2020/0285694 A1
(43) Pub. Date: Sep. 10, 2020

(54) Spreadsheet Application Computing Environment

(71) Applicant: Thomas Michael Nield, Frisco, TX (US)

(72) Inventor: Thomas Michael Nield, Frisco, TX (US)

(21) Appl. No.: 16/417,922

(22) Filed: May 21, 2019

Related U.S. Application Data
(60) Provisional application No. 62/815,498, filed on Mar. 8, 2019.

(51) Int. Cl. G06F 17/24; G06F 9/455

(52) U.S. Cl. CPC G06F 17/246; G06F 9/45504

(57) ABSTRACT

In a general aspect, a computer resource runs computer code from one or more cells of a spreadsheet. In some aspects, a spreadsheet application detects computer program script stored in a cell of an electronic spreadsheet document. A computer resource is then identified to execute the computer program script (e.g., based on a computer programming language of the computer program script). The computer resource is invoked to execute the computer program script, and the computer resource generates output data by executing the computer program script. The output data are converted to cell values for the electronic spreadsheet document, and the spreadsheet application populates the cell values into one or more cells of the electronic spreadsheet document.

### CROSS-REFERENCE TO RELATED APPLICATIONS

This application claims priority to U.S. Provisional Application No. 62/815,498 entitled “Spreadsheet Application Computing Environment” and filed Mar. 8, 2019. The priority application is hereby incorporated by reference.

### BACKGROUND

The following description relates to a spreadsheet application computing environment.

Computer applications such as Microsoft Excel and Google Sheets are used to create and render electronic spreadsheet documents. Such computer applications are used for many different purposes in a variety of industries. A spreadsheet document typically includes worksheets that contain rows and columns of cells, and each individual cell can store text values, numeric values, or formulas.

### DESCRIPTION OF DRAWINGS

FIG. 1 is a diagram of an example computer system.

FIG. 2 is a diagram of an example spreadsheet computer application environment.

FIG. 3 is a screenshot of an example spreadsheet computer application rendering an electronic spreadsheet document.

FIGS. 4A and 4B are screenshots showing an example rendering of cells and a cell code editor for an electronic spreadsheet document.

FIGS. 5A and 5B are screenshots showing an example rendering of cells and a cell code editor for an electronic spreadsheet document.

FIGS. 6A and 6B are screenshots showing an example rendering of cells and a cell code editor for an electronic spreadsheet document.

FIG. 7 is a screenshot showing an example rendering of cells and a function box for an electronic spreadsheet document.

FIG. 8 is a screenshot showing an example rendering of cells and a function box for an electronic spreadsheet document.

FIG. 9 is a screenshot showing an example rendering of cells and a function box for an electronic spreadsheet document.

FIG. 10 is a screenshot showing an example rendering of cells and a function box for an electronic spreadsheet document.

FIG. 11 is a screenshot showing an example rendering of cells and a function box for an electronic spreadsheet document.

### DETAILED DESCRIPTION

In some aspects of what is described here, a spreadsheet application computing environment can run code stored in one or more cells of a spreadsheet. For example, spreadsheet cells can contain script written in any type of programming language, and a spreadsheet application (or another application in the computing environment with the spreadsheet application) may be configured to interpret and execute the script, for example, by invoking an appropriate compiler, interpreter or engine in the computing environment. In some implementations, the script stored in a spreadsheet can be written, for example, in Python, R, Java, the CellScript language described below, or another type of programming language.

The script stored in the cell of a spreadsheet may generally include any type function, command, or other operation that can be executed by the relevant programming language. For instance, the script may include code that defines variables, code that defines “do” loops, “for” loops or other types of multi-line operations, code that performs a function call, etc. The output of the script can be populated into one or more cells of the spreadsheet or handled in another manner. In some cases, the script stored in the cell of a spreadsheet can produce tabular structures or other types of data structures that can be rendered within the spreadsheet (e.g., stored in other cells of the spreadsheet, etc.).

In some implementations, the systems, devices and methods described here can provide technical advantages over, or improvements to, existing technologies. For example, spreadsheet can be programmed to perform a broader array of complex tasks, including a larger spectrum of automation (e.g., iterating and formatting cells in a specific way after another cell value changes, etc.). In some cases, a spreadsheet can be programmed (e.g., by a user) to perform complicated data wrangling and analytics like machine learning within a spreadsheet environment. In some cases, a spreadsheet can be programmed (e.g., by a user) to iterate experimental workflows much more quickly over spreadsheet data, and cell change triggers may automatically update the models/data transformations. In addition, the systems, devices and methods described here may, in some instances, provide more robust functionality that can reduce or even prevent the types of costly mistakes that have historically been caused by spreadsheet errors.

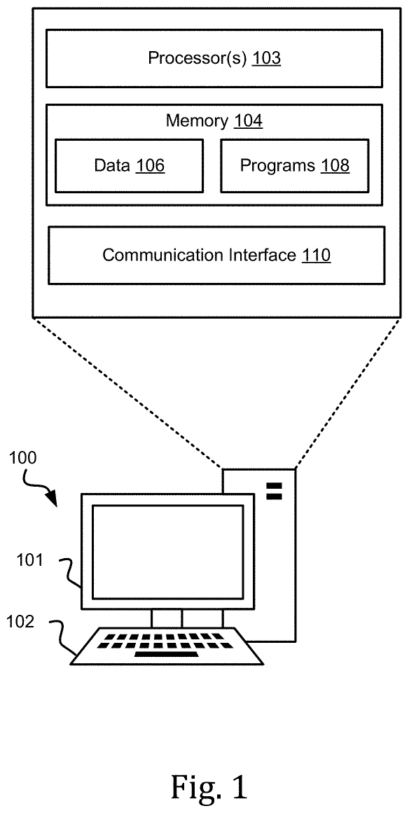

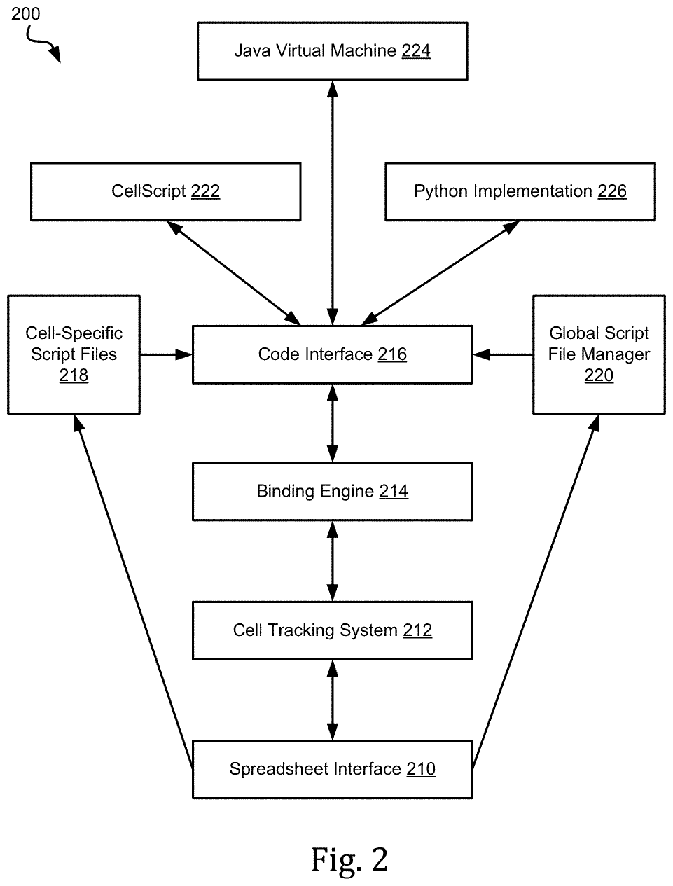

FIG. 1 is a schematic diagram of an example computer system 100. The example computer system 100 includes a display device 101, an input device 102, processor(s) 103, memory 104 and a communication interface 110. The computer system 100 may include additional components, such as, for example, input/output controllers, communication links, etc. The computer system 100 can be used, for example, to execute a spreadsheet application in a computing environment. For instance, the computer system 100 may be used to implement one or more aspects of the systems and methods described with respect to FIG. 2, systems and methods described herein, or to perform other types of operations.

The memory 104 can include, for example, a random access memory (RAM), a storage device (e.g., a writable read-only memory (ROM) or others), a hard disk, or another type of storage medium. The memory 104 can include various forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The computer system 100 can be preprogrammed or it can be programmed (and reprogrammed) by loading a program from another source (e.g., from a CD-ROM, from another computer device through a data network, or in another manner). The memory 104 can store instructions (e.g., computer code) associated with an operating system, computer applications, and other resources. The memory 104 can also store application data and data objects that can be interpreted by one or more applications or virtual machines running on the computer system 100. In the example shown in FIG. 1, the memory 104 stores data 106 and programs 108.

The communication interface 110 can be coupled to input devices and output devices (e.g., the display device 101, the input device 102, or other devices) and to one or more communication links. In the example shown, the display device 101 is a computer monitor, and the input device 102 is a keyboard. The computer system 100 may include other types of input devices, output devices, or both (e.g., mouse, touchpad, touchscreen, microphone, motion sensors, etc.). The input devices and output devices can receive and transmit data in analog or digital form over communication links such as a wired link (e.g., USB, etc.), a wireless link (e.g., Bluetooth, NFC, infrared, radio frequency, or others), or another type of link.

The communication interface 110 may be connected to a communication link, which may include any type of communication channel, connector, data communication network, or other link. For example, the communication link can include a wireless or a wired network, a Local Area Network (LAN), a Wide Area Network (WAN), a cellular network, a private network, a public network (such as the Internet), a WiFi network, a network that includes a satellite link, or another type of data communication network.

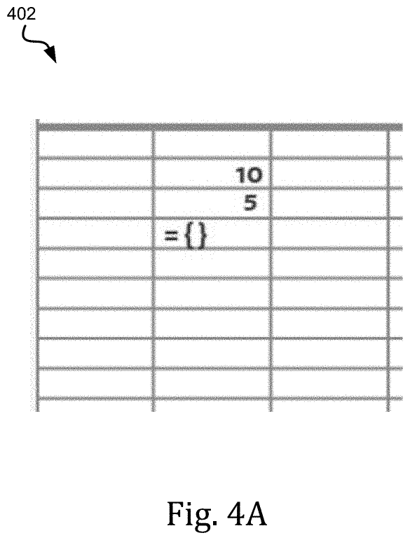

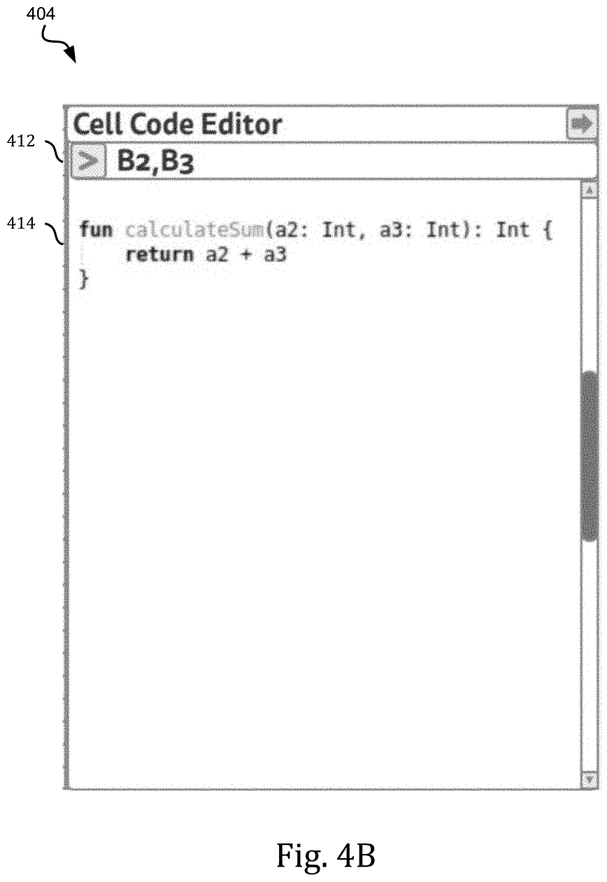

The programs 108 can include software applications, scripts, programs, functions, executables, or other modules that are interpreted or executed by the processor(s) 103. Such applications may include machine-readable instructions for performing one or more of the operations described below. The programs 108 may include one or more spreadsheet applications, which may include the example components shown in FIG. 2 or other types of components. The programs 108 may include machine-readable instructions for generating a user interface, such as, for example, those represented in FIGS. 4A, 4B, 5A, 5B, 6A, 6B, 7, 8, 9, 10 and 11. The programs 108 can obtain input data from the memory 104, from another local source, or from one or more remote sources (e.g., via a communication link). The programs 108 can generate output data and store the output data in the memory 104, in another local medium, or in one or more remote devices (e.g., by sending the output data via the communication link). The programs 108 (also known as, software, software applications, scripts, or codes) can be written in any form of programming language, including compiled or interpreted languages, declarative or procedural languages. A computer program can be deployed to be executed on one computer or on multiple computers that are located at one site or distributed across multiple sites and interconnected by a communication network. For instance, a computer application may operate in the cloud, and the computer system 100 may access the computer application through an Internet connection.

The processor(s) 103 can include any type of data processor that executes instructions, for example, to generate output data based on data inputs. For example, the processor(s) 103 can run the programs 108 by executing or interpreting the scripts, functions, executables, or other modules contained in the programs 108. The processor(s) 103 may perform one or more of the operations described, for example, below.

The processor(s) 103 can include various kinds of apparatus, devices, and machines for processing data, including, by way of example, a programmable data processor, a system on a chip, or multiple ones, or combinations, of the foregoing. The processor(s) 103 can include special purpose logic circuitry, e.g., an FPGA (field programmable gate array) or an ASIC (application specific integrated circuit). The processor(s) 103 can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The processor(s) 103 can include, by way of example, both general and special purpose microprocessors, and processors of any kind of digital computer.

FIG. 2 is a diagram of an example spreadsheet computer application environment 200. The example spreadsheet computer application environment 200 may be implemented, for example, by one or more computer applications deployed on one or more computer systems. For instance, a spreadsheet computer application environment may be deployed as an installed application on a workstation, as an “app” on a tablet or smartphone, as a cloud-based application running on one or more servers accessed by user devices, or otherwise.

The example spreadsheet computer application environment 200 includes a spreadsheet interface 210, a cell tracking system 212, a binding engine 214, a code interface 216, cell-specific script files 218, a global script file manager 220, a CellScript interpreter 222, a Java Virtual Machine 224 and a Python Implementation 226. The example components shown in FIG. 2 can be implemented, for instance, as computer application modules or other types of computer elements. A spreadsheet computer application environment may include additional or different components and features. In some cases, one or more of the example components shown in FIG. 2 may be omitted or configured in another manner, or multiple components may be combined and deployed as a single component.

In some cases, the spreadsheet computer application environment 200 may operate in connection with, or include some or all of the functionality of, a conventional spreadsheet application (e.g., Microsoft Excel, Apple Numbers, Google Sheets, etc.). For instance, the spreadsheet interface 210 and the cell tracking system 212 may be capable of processing spreadsheet documents formatted for a conventional spreadsheet application (e.g., Microsoft Excel, Apple Numbers, Google Sheets, etc.). As described below, the spreadsheet computer application environment 200 can include other types of capabilities and process other types of spreadsheet documents, including the ability to process computer program scripts stored in the cells of spreadsheet documents.

In some aspects of operation, the spreadsheet interface 210 loads a spreadsheet document (e.g., into memory from storage or from a remote device), and reads the various cells of the spreadsheet document. The cell tracking system 212 monitors the cells of the spreadsheet document and initiates callbacks invoked by the contents of the cells. In some cases, the cell tracking system 212 identifies one or more cells that contain a computer program script, and delivers the computer program script to the binding engine 214.

In some instances, the binding engine 214 provides an interface between the inputs and outputs of the computer program script. In the example shown in FIG. 2, the binding engine 214 is shown as an interface between the cell tracking system 212 and the code interface 216, but the binding engine 214 may encompass plugins that operate with other programming languages and platforms, as well as other components shown in FIG. 2. For example, the binding engine 214 may include one or more of the code interface 216, the cell-specific script files 218, the global script file manager 220, the CellScript interpreter 222, the Java Virtual Machine 224, the Python Implementation 226, and potentially other components. In some cases, the third-party plugins conform to an interface provided by the binding engine 214. In some cases, the binding engine 214 compiles codes, maintains runtime environments, handles concurrency/multithreaded calculations, and performs other systematic operations to make different programming platforms work within a spreadsheet or a spreadsheet application computing environment.

In the example shown in FIG. 2, the binding engine 214 sends the computer program script to the code interface 216. The code interface 216 receives the computer program script from the binding engine 214 and identifies an appropriate resource to execute the computer program script. The code interface 216 sends the computer program script to the identified resource to be executed. In some cases, the computer program resource includes a compiler or interpreter that compiles or interprets the computer program script for execution. Compilation generally refers to the process of converting the computer program script to a more low-level computer language (e.g., Java code is typically converted to bytecode by a compiler). Interpreted languages do not require a compiler. For example, Python uses an interpreter; Python code is interpreted at runtime and not converted into a low-level set of computer instructions by a compiler.

In some cases, the cell-specific script file manager 218 obtains data from the spreadsheet interface 210 and provides the data to the code interface 216. For example, the computer program script may refer to other cells of the spreadsheet document, and the cell-specific script file manager 218 may obtain current cell values or other information from the spreadsheet document. In some cases, the global script file manager 220 obtains data from the spreadsheet interface 210 and provides the data to the code interface 216. For example, the computer program script may refer to global properties or values defined in the spreadsheet application, and the global script file manager 220 may obtain properties or values defined by the native spreadsheet application or other types of information.

In some instances (when the computer program script is written in CellScript language), the code interface 216 sends the computer program script to the CellScript engine 222, and the CellScript engine 222 runs the computer program script and returns one or more outputs to the code interface 216. In some instances (when the computer program script is written in Java, Kotlin, Scala, Groovy, Clojure, etc.), the code interface 216 sends the computer program script to the Java Virtual Machine 224, and the Java Virtual Machine 224 runs the computer program script and returns one or more outputs to the code interface 216. In some instances (when the computer program script is written in Python), the code interface 216 sends the computer program script to the Python Implementation 226, and the Python Implementation 226 runs the computer program script and returns one or more outputs to the code interface 216. In some instances (when the computer program script is written in another language), the code interface 216 sends the computer program script to another resource, and the resource runs the computer program script and returns one or more outputs to the code interface 216.

Thus, the code interface 216 receives one or more outputs generated by the identified computer resource executing the computer program script. The code interface 216 then delivers the one or more outputs the binding engine 214. The binding engine 214 converts the output to a format that can be interpreted by the cell tracking system 212. For example, the binding engine 214 may designate values for one or more cells of the spreadsheet document (in some cases, a tabular structure), based on the output received from the code interface 216. The cell tracking system 212 can then provide the cell values to the spreadsheet interface 210, and the spreadsheet interface 210 can render the output values within the spreadsheet.

In some cases, the spreadsheet interface 210 can also generate a graphical representation of the spreadsheet document, for example, to be displayed on a user interface device. In some cases, the spreadsheet interface 210 can generate a graphical representation as shown by one or more of the examples in FIGS. 4A, 4B, 5A, 5B, 6A, 6B, 7, 8, 9, 10 and 11.

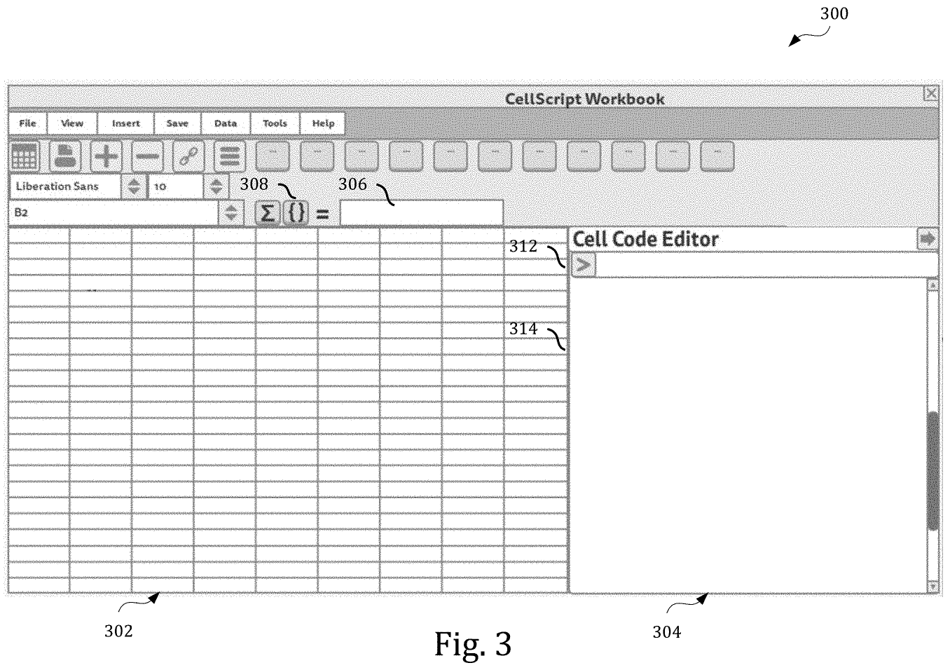

FIG. 3 is a screenshot 300 of an example spreadsheet computer application's rendering of an electronic spreadsheet document within a graphical user interface. The rendering represented by the screenshot 300 can be displayed on a display device (e.g., on a touchscreen, laptop screen, computer monitor, etc.), for presentation to a user. In the example shown in FIG. 3, the graphical user interface includes a rendering of the cells 302 of the electronic spreadsheet document, along with a rendering of a cell code editor 304, a function box 306, a code toggle button 308, and other graphical elements. In some implementations, the graphical user interface represented by the screenshot 300 includes one or more graphical interface elements that are similar to those presented by conventional spreadsheet applications (e.g., drop down menus (“File”, “View”, “Insert”, etc.), shortcuts (“Copy”, “Paste”, “Save”, etc.), etc.).

In the example shown in FIG. 3, the cells 302 are empty, since no content has been stored in any of the cells of the electronic spreadsheet document. The cells 302 may generally store any type of spreadsheet data such as, for example, text, numeric values, formulas, etc. In some instances, one or more of the cells 302 stores computer code that is configured to interact with other cells of the electronic spreadsheet document. For example, a cell may store a computer program script that obtains input data from one or more cells, stores output data in one or more cells, or both.

In some implementations, a spreadsheet application provides a function box (e.g., the function box 306 shown in FIG. 3 or otherwise) where CellScript code can be entered by a user. If the computing environment is set up properly with another programming resource (e.g. Python or Java), the script language for the other programming resource may be used to drive how a cell calculates a value or data set.

In the example shown in FIG. 3, the content stored in a cell may be input or edited by selecting the cell and entering (or editing) cell content in the cell code editor 304 or the function box 306 (or both). In some examples, the function box 306 may be useful for quickly entering numeric or text values or shorter formulas and scripts, while the cell code editor 304 may be useful for entering longer computer program scripts (e.g., multi-line functions, etc.). In the example shown in FIG. 3, the code toggle button 308 can be selected to open the cell code editor 304 for entering computer program script in a selected cell. A spreadsheet application may provide additional or different types of interfaces for editing cell contents in a spreadsheet environment. The “={ }” value can be entered in the function box 306 to provide a placeholder when a user is editing the code for that cell in the cell code editor 304, and upon exiting it will calculate the function's returned value.

The example cell code editor 304 includes an input cell reference field 312 and a code editor field 314. A cell code editor may include additional or different features in some cases. The code editor field 314 provides a programming interface for a computer programming platform (e.g., JVM, Python, etc.). For example, computer program script to be stored in a cell may be entered directly (e.g., as alphanumeric characters) in the code editor field 314. In the example shown, the input cell reference field 312 provides an interface for designating other cells of the spreadsheet document to provide input data for the computer program script in the code editor field 314.

In some aspects of operation, a computer program script is entered in one of the cells 302 through the cell code editor 304 (and/or the function box 306), and the computer program script is then stored in the cell of the electronic spreadsheet document (e.g., in memory or storage). The spreadsheet application detects the computer program script and identifies an appropriate computer resource to execute the script. For instance, the spreadsheet application may identify the computer resource based on the programming language in which the computer program script is written. In some cases, input data are obtained based on the compute program script. For example, the input data may be obtained from other cells of the spreadsheet document (e.g., based on cells entered in the input cell reference field 312), from the spreadsheet application, from an external source (e.g., the Internet) or external device, etc. The computer resource is then invoked to execute the computer program script, and the input data may be provided to the computer resource for use in executing the script. The computer resource generates output data by executing the computer program script, and the output data are converted to cell values for the electronic spreadsheet document. The spreadsheet application may then store the cell values in one or more cells of the electronic spreadsheet document (e.g., in memory or storage).

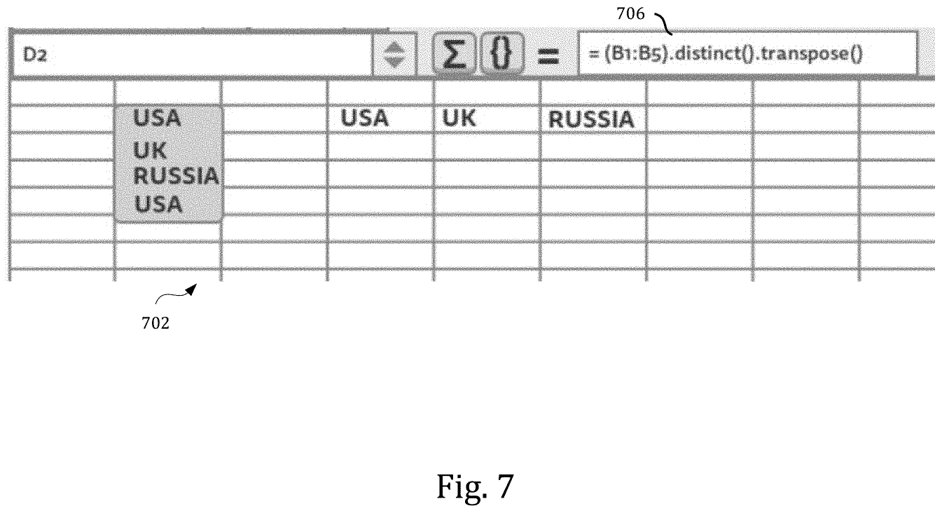

Examples of computer program script in an electronic spreadsheet document are shown in FIGS. 4A, 4B, 5A, 5B, 6A, 6B, 7, 8, 9, 10 and 11. In each of these examples, the computer program script stored in one or more cells of the spreadsheet document can be executed by a computer resource other than the spreadsheet application itself. For instance, the spreadsheet application may provide the computer program script to a binding engine, which may identify and invoke the appropriate computer resource to execute the computer program script (e.g., as described with respect to FIG. 2). In some instances, the binding engine obtains input data (e.g., from other cells of the spreadsheet document) and provides the input data to the computer resource for use in executing the computer program script. The binding engine may receive the output data from the computer resource and provide the output data back to the spreadsheet application, for example, to be stored in the spreadsheet or handled in another manner. The example computer program scripts shown in FIGS. 4B, 5B and 6B are written in the Kotlin programming language, and the example computer program scripts shown in FIGS. 7, 8, 9, 10 and 11 are written in the CellScript programming language. Other types of programming languages may be used in some cases.

FIGS. 4A and 4B are screenshots showing an example rendering of cells 402 and a cell code editor 404 for an electronic spreadsheet document. For instance, the example cells 402 and the example cell code editor 404 may be presented within a graphical user interface such as, for example, the graphical user interface represented by the screenshot 300 shown in FIG. 3.

As shown in FIG. 4A, two cells (cells B2 and B3) in the spreadsheet store numeric values (“10” and “5”), and another cell (cell B4) in the spreadsheet stores computer program script, as indicated by the “={ }” characters in the cell rendering. The computer program script stored in the cell is shown in the cell code editor 404 in FIG. 4B. As shown in FIG. 4B, the input cell reference field 412 refers to cells B2 and B3, which are the cells that store the numeric values (“10” and “5”) shown in FIG. 4A. The example computer program script in the cell code editor 404 can be executed by a computer resource, for example, as described with respect to FIG. 2.

In the example shown in FIG. 4B, the computer program script is a function that computes the sum of two input cell values, namely the numeric values stored in cells B2 and B3 (as indicated in the input cell reference field 412). The function in the example computer program script shown in FIG. 4B computes a sum, and provides the sum as output data, which can then be converted to a cell value and populated into one of the cells of the spreadsheet (e.g., cell B4 in FIG. 4A).

The example shown in FIGS. 4A and 4B provides an example of how a third-party language can define a cell's contents. In particular, the example computer program script shown in FIG. 4B is written in the Kotlin programming language, which is an example of a Java-based language that can run on a Java Virtual Machine. As shown in FIG. 4B, cells B2 and B3 are listed as the parameter cells in the input cell reference field 412, and are passed to a function that accepts those two parameters accordingly. In this example, the function shown in FIG. 4B will be re-executed only when those two cells change in value.

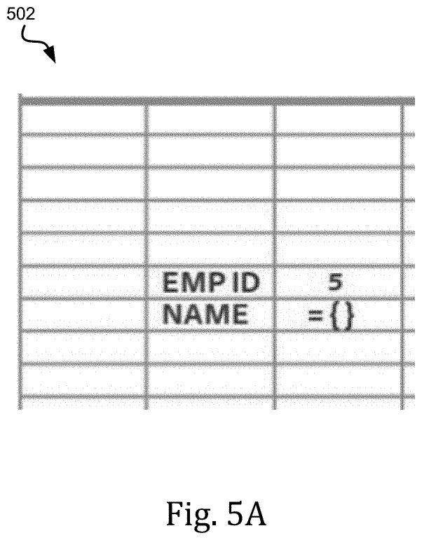

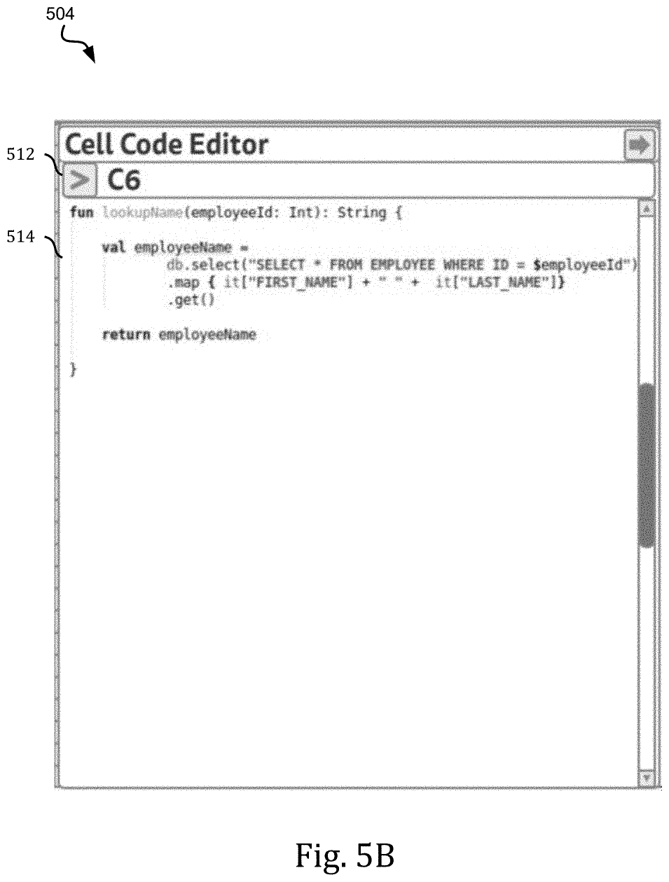

FIGS. 5A and 5B are screenshots showing an example rendering of cells 502 and a cell code editor 504 for an electronic spreadsheet document. For instance, the example cells 502 and the example cell code editor 504 may be presented within a graphical user interface such as, for example, the graphical user interface represented by the screenshot 300 shown in FIG. 3.

As shown in FIG. 5A, one cell (cell C6) in the spreadsheet stores a numeric value (“5”), and another cell (cell C7) in the spreadsheet stores computer program script, as indicated by the “={ }” characters in the cell rendering. The computer program script stored in the cell is shown in the cell code editor 504 in FIG. 5B. As shown in FIG. 5B, the input cell reference field 412 refers to cell C6, which is the cell that stores the numeric value (“5”) shown in FIG. 5A. The example computer program script in the cell code editor 504 can be executed by a computer resource, for example, as described with respect to FIG. 2.

In the example shown in FIG. 5B, the computer program script is a function that constructs a string representing an employee's name, in particular the name corresponding to the employee ID number stored in cell C6 (as indicated in the input cell reference field 512). The function in the example computer program script shown in FIG. 5B constructs an output string from data stored in an external database. The “FIRST_NAME” and “LAST_NAME” elements are retrieved from the external database based on the employee ID provided as input. The function provides the output string as output data, which can then be converted to a cell value and populated into one of the cells of the spreadsheet (e.g., cell C7 in FIG. 5A).

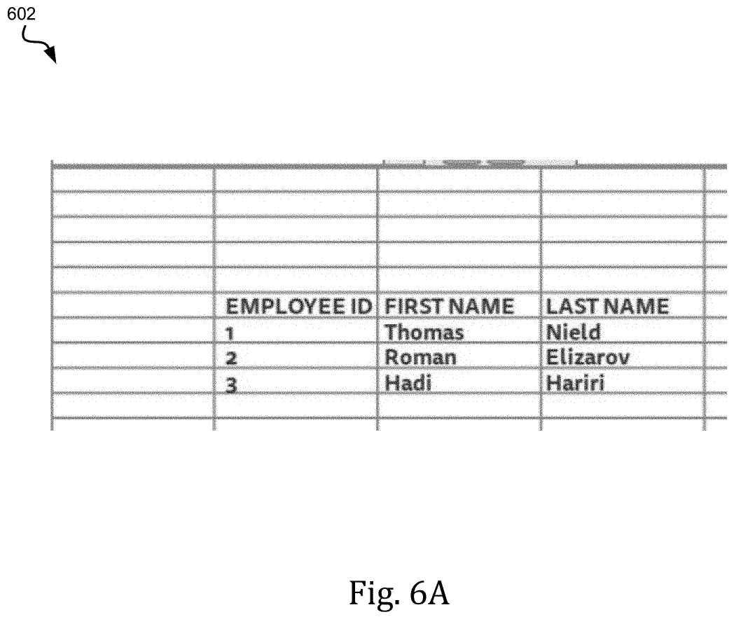

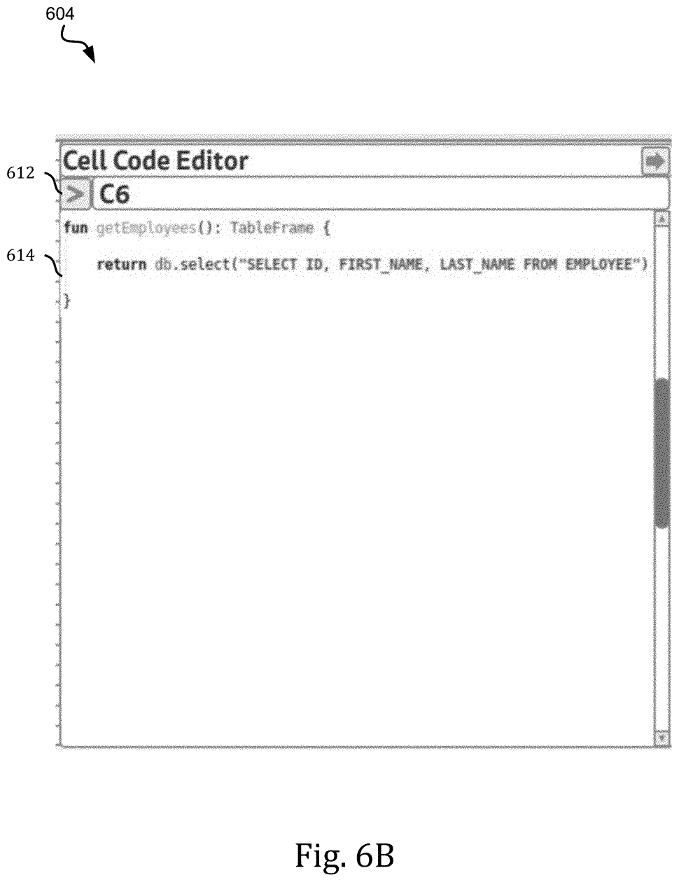

FIGS. 6A and 6B are screenshots showing an example rendering of cells 602 and a cell code editor 604 for an electronic spreadsheet document. For instance, the example cells 602 and the example cell code editor 604 may be presented within a graphical user interface such as, for example, the graphical user interface represented by the screenshot 300 shown in FIG. 3.

The tabular structure of employees in FIG. 6A is the rendered output of a script stored in cell C6. The script stored in cell C6, shown in the example cell code editor 604 in FIG. 6B, connects to an external database and returns three columns of employee data in the form of a tabular structure, called a TableFrame. The output table is then projected back to cell C6, and the tabular data is spilled to the neighboring cells as shown in FIG. 6A.

FIG. 7 is a screenshot showing an example rendering of cells 702 and a function box 706 for an electronic spreadsheet document. For instance, the example cells 702 and the example function box 706 may be presented within a graphical user interface such as, for example, the graphical user interface represented by the screenshot 300 shown in FIG. 3.

As shown in FIG. 7, four cells (cells B2, B3, B4, B5) in the spreadsheet store text values corresponding to country names, and another cell (cell D2) in the spreadsheet stores computer program script. The computer program script stored in the cell is shown in the function box 706 in FIG. 7. The example computer program script in the function box 706 can be executed by a computer resource, for example, as described with respect to FIG. 2.

In the example shown in FIG. 7, the computer program script constructs a table of distinct items from the input cells (B1:135). The example computer program script shown in FIG. 7 constructs an output table by transposing the distinct items in the input data retrieved from cells B1 through B5. The output table is provided as output data, which can then be converted to cell values (which may be formatted as a table or otherwise in the spreadsheet). In the example shown, the elements of the output table are converted to cell values which are populated into cells D2:F2 in the spreadsheet.

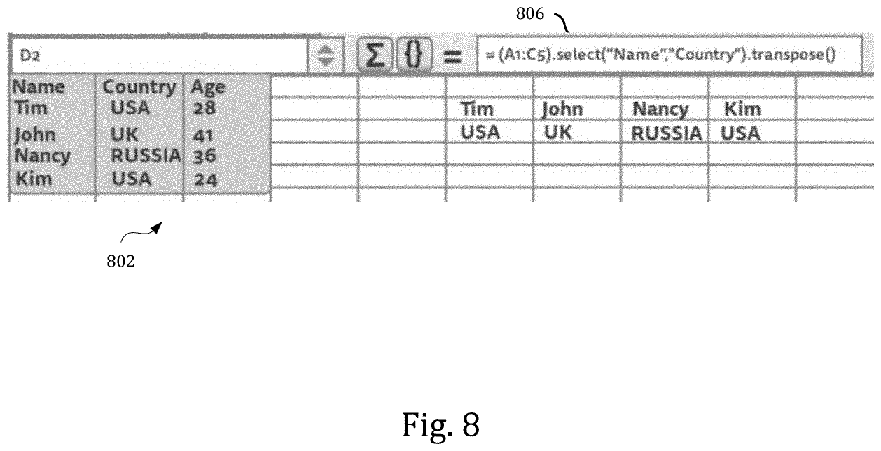

FIG. 8 is a screenshot showing an example rendering of cells 802 and a function box 806 for an electronic spreadsheet document. For instance, the example cells 802 and the example function box 806 may be presented within a graphical user interface such as, for example, the graphical user interface represented by the screenshot 300 shown in FIG. 3.

As shown in FIG. 8, a range of cells (cells A1:C5) in the spreadsheet store a table of text and numeric values corresponding to names, countries and ages, and another cell (cell F2) in the spreadsheet stores computer program script. The computer program script stored in the cell is shown in the function box 806 in FIG. 8. The example computer program script in the function box 806 can be executed by a computer resource, for example, as described with respect to FIG. 2.

In the example shown in FIG. 8, the computer program script constructs a table of selected items from the input cells (A1:C5). The example computer program script shown in FIG. 8 constructs an output table from the selected input data (names and country names) retrieved from the input table, and transposes the input data to form the output table. The output table is then provided as output data, which can then be converted to cell values (which may be formatted as a table or otherwise in the spreadsheet). In the example shown, the elements of the output table are converted to cell values which are populated into cells F2:I3 in the spreadsheet.

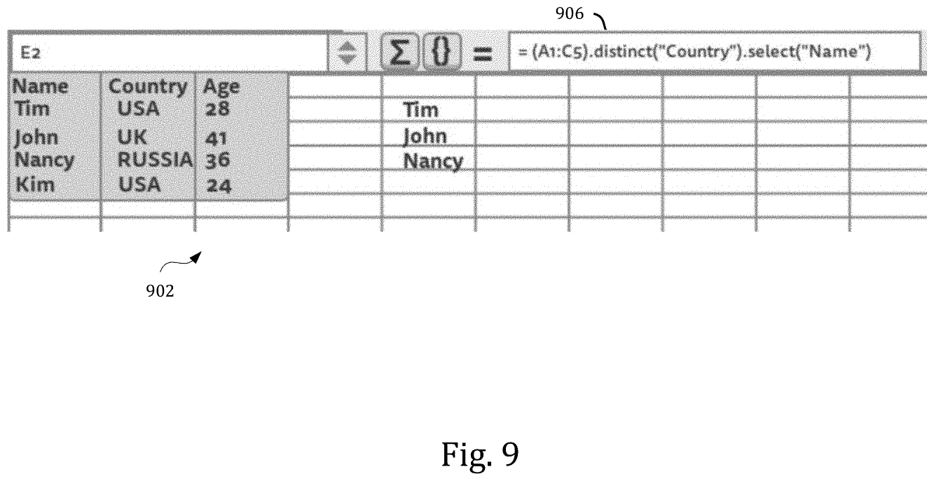

FIG. 9 is a screenshot showing an example rendering of cells 902 and a function box 906 for an electronic spreadsheet document. For instance, the example cells 902 and the example function box 906 may be presented within a graphical user interface such as, for example, the graphical user interface represented by the screenshot 300 shown in FIG. 3.

As shown in FIG. 9, a range of cells (cells A1:C5) in the spreadsheet store a table of text and numeric values corresponding to names, countries and ages, and another cell (cell E2) in the spreadsheet stores computer program script. The computer program script stored in the cell is shown in the function box 906 in FIG. 9. The example computer program script in the function box 906 can be executed by a computer resource, for example, as described with respect to FIG. 2.

In the example shown in FIG. 9, the computer program script constructs a table of selected items from the input cells (A1:C5). The example computer program script shown in FIG. 9 constructs an output table from the selected input data (names) retrieved from the input table, and provides the output table as output data, which can then be converted to cell values (which may be formatted as a table or otherwise in the spreadsheet). In the example shown, the elements of the output table are converted to cell values which are populated into cells E2:E4 in the spreadsheet.

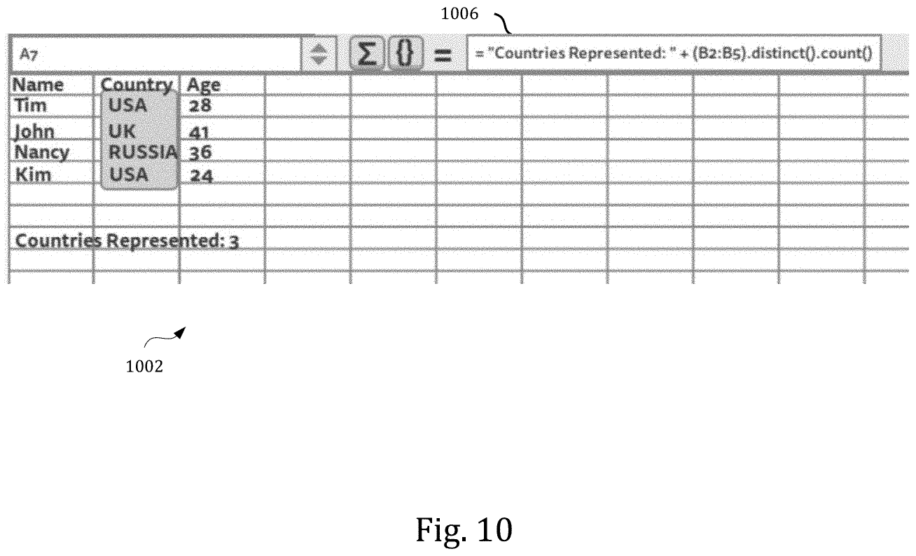

FIG. 10 is a screenshot showing an example rendering of cells 1002 and a function box 1006 for an electronic spreadsheet document. For instance, the example cells 1002 and the example function box 1006 may be presented within a graphical user interface such as, for example, the graphical user interface represented by the screenshot 300 shown in FIG. 3.

As shown in FIG. 10, a range of cells (cells A1:C5) in the spreadsheet store a table of text and numeric values corresponding to names, countries and ages, and another cell (cell A7) in the spreadsheet stores computer program script. The computer program script stored in the cell is shown in the function box 1006 in FIG. 10. The example computer program script in the function box 1006 can be executed by a computer resource, for example, as described with respect to FIG. 2.

In the example shown in FIG. 10, the computer program script constructs a string from the input cells (B2:135). The example computer program script shown in FIG. 10 constructs the output string from the selected input data (country names) retrieved from the input table, and computes the number of distinct input data items. The output string indicating the number of distinct country names is provided as output data, which can then be converted to cell values. In the example shown, the output string (“Countries Represented: 3”) is converted to a cell value which is populated into cell F2 in the spreadsheet.

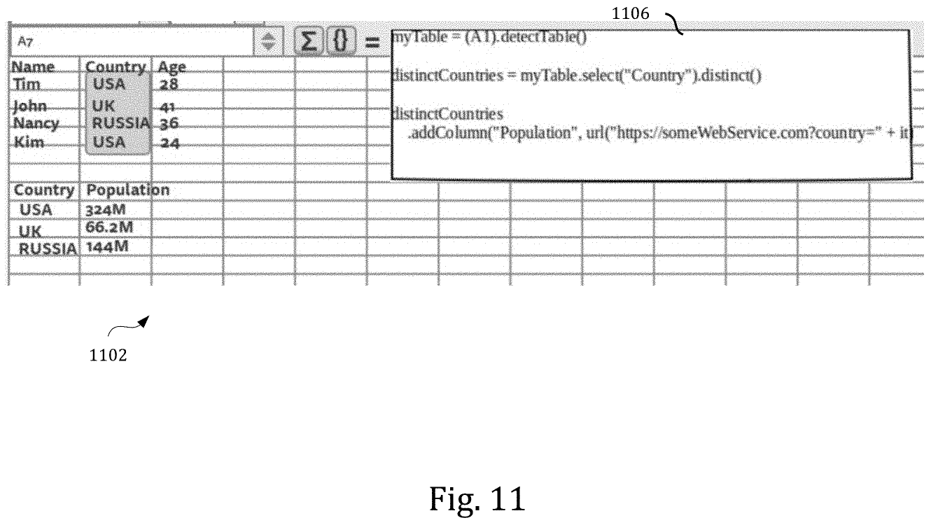

FIG. 11 is a screenshot showing an example rendering of cells 1102 and a function box 1106 for an electronic spreadsheet document. For instance, the example cells 1102 and the example function box 1106 may be presented within a graphical user interface such as, for example, the graphical user interface represented by the screenshot 300 shown in FIG. 3.

As shown in FIG. 11, a range of cells (cells A1:C5) in the spreadsheet store a table of text and numeric values corresponding to names, countries and ages, and another cell (cell A7) in the spreadsheet stores computer program script. The computer program script stored in the cell is shown in the function box 1106 in FIG. 11. The example computer program script in the function box 1106 can be executed by a computer resource, for example, as described with respect to FIG. 2.

In the example shown in FIG. 11, the computer program script constructs a table from the input table (A1:C5) and from external data. The example computer program script shown in FIG. 10 constructs the output table from the selected input data (country names) retrieved from the input table and additional input data (country populations) retrieved from a web address via Internet. The output table is provided as output data, which can then be converted to cell values. In the example shown, the output table is converted to cell values that are populated into cells A7:B10 in the spreadsheet.

The example computer program scripts shown in FIGS. 7, 8, 9, 10 and 11 are written in a scripting language (referred to here as “CellScript”) that can be syntactically optimized for spreadsheet operations, including traversing cell ranges and projecting tabular outputs (e.g., with formatting) onto spreadsheets. Other programming languages may be used, such as, for example, JVM languages like Kotlin shown in FIGS. 4B, 5B, and 6B. In some implementations, an electronic spreadsheet document can be composed of a spreadsheet workbook and a code project, composed of spreadsheets, code files, data sets, SQL queries, libraries, and build systems. The spreadsheet application environment may operate as an integrated development environment with spreadsheets. For workbooks with Python/R/Java code, the source code can easily be exported into a Python/R/Java library for software development operations. The spreadsheet application environment may bring some or all these tools together, for example, to empower better logic expressability and modern analytics libraries and tooling.

In some instances, a scripting language for spreadsheet application environments can include features that provide a number of technical benefits and advantages. For instance, the CellScript language described here: uses familiar cell range syntax (e.g. A1:A100); can be expressed in a single line to resemble a “formula” (e.g. (A1:A100). countIf(it<5)/transactions.count( )); supports variables, loops, fluent operators, and other basic scripting constructs; can use traditional function calls or modern fluent chaining operators (e.g. COUNT(A1:A100) versus (A1:A100).count( ) is capable of pulling data from databases, web services, files, and other external resources; and can be expressed in multiple lines for more complex operations, helping maintainability and legibility as demonstrated below:

transactions = (A1:A100)
overFiveDollars = (A1:A100).filter(it > 5)
overFiveDollars.count( ) / transactions.count( )

In some implementations, a scripting language for spreadsheet application environments can include a specialized TableFrame API that expresses and manipulates tabular operations inside code and can be mapped to spreadsheet ranges. For instance, the CellScript language described here can create, identify, or pull tabular data (expressed as a TableFrame) which will spill into a contiguous region of cells to display data (e.g., TableFrame (B1:B100). distinct ( ). transpose ( )); and can also contain formatting and other metadata attached to the cells. In some cases, TableFrames may include operators to do common tabular manipulations within scripting (selecting, filtering, grouping, transposing, etc) as shown below:

myTable = (A1).detectTable( )
countryCount = myTable.select(“COUNTRY”).distinct( ).count( )

In some implementations, a scripting language for spreadsheet application environments can include a specialized CellFrame API that contains arbitrary arrangements of cells outputted to a contiguous area of the spreadsheet. The CellFrame API may be similar to the TableFrame API described above, but may be non-tabular. Both the CellFrame and TableFrame API may also contain formatting and other metadata.

In some implementations, a scripting language for spreadsheet application environments can provide extensibility to other programming languages with full package/library support (including analysis and machine learning libraries like NumPy, TensorFlow, Scikit-learn, etc). For example, the scripting language may support libraries provided by CellScript, Python, R, Java, Kotlin, and possibly others.

In some implementations, a spreadsheet application environment can utilize a workbook structure with several types of sheets, for example: SpreadSheet, TableSheet (backed by SQL queries, web services, scripts creating a TableFrame, etc); code sheet (for holding global functions in CellScript, Python, etc); dashboard sheet (with programmable UI controls); pivot table; graphs and charts. In some implementations, a spreadsheet application environment can provide a scripting API to interact with workbook elements and automate tasks: cells, sheets, pivot tables, charts, custom UI controls, etc. The spreadsheet application environment may allow easy extraction of code modules for software development.

The CellScript scripting language described here is designed to be simple enough for basic business users. The CellScript scripting language may, in some cases, be expressable in a single line, or it may be expressed as multi-line and leverage variables, loops, fluent operators, databases, and other “scripting” functionality. CellScript can support both nested function calls as well as fluent chaining of operators. There is also a feature to support languages beyond CellScript like Python, R, and Java. This will enable a vast frontier for spreadsheet analysis by bringing in machine learning and other analytics libraries, to close the existing gap between spreadsheets and scripting.

The following discussion provides examples of the CellScript scripting language. The following example computer program script computes a percentage of transactions over $5:

**1**
(A1:A100).countIf(it > 5) / transactions.count( )
**2**
transactions = TableFrame(A1:B100)
transactions.countIf(it[“AMOUNT”] > 5) /
COUNT(transactions)
**3**
transactions = (A1:A100)
overFiveDollars = (A1:A100).filter(it > 5)
COUNT(overFiveDollars) / COUNT(transactions)

The following example computer program script gets distinct list of countries out of a tabular data set, and displays them horizontally:

**1**
transpose(distinct(B1:B100) )
**2**
(B1:B100).distinct( ).transposed( )
**3**
countries = (B1:B100)
distinctCountries = countries.distinct( )
distinctCountries.transpose ( )
**4**
myTable = (A1).detectTable( )
myTable.select(“COUNTRY”).distinct( ).transpose( )
**5**
personAndCountry = (A1:B100)
personAndCountry.columns[1].distinct( ).transpose

The following example computer program script gets a distinct list of countries and attaches their population from a web service:

countries = (B1:B100)
distinctCountries = countries.distinct( )
distinctCountries .addColumn(“Population”,

url(“https://someWebService.com?country=” + it)

The following discussion provides information on certain aspects of the CellScript scripting language. The CellScript scripting language can be syntactically optimized for iterating and manipulating spreadsheets and cells. Scripting capabilities can be much more robust compared to traditional spreadsheet formulas. CellScript strives to be pragmatically minimalist; for example, CellScript may be deployed without classes to keep the language streamlined towards spreadsheets and tabular data operations. Other types of programming or scripting can be done with Python, R, Java, or another 3rd party language supported via a plugin. Cells can be iterated and manipulated with CellScript in a variety of ways, including the usage of TableFrames and CellFrames. Many operations, like mathematical ones, may assume to operate on the cells' values. Others operations may allow manipulation of cells on their other properties like fill color, comments, formatting, and other metadata. CellScript functions can be defined within a cell (e.g., replacing the traditional “formula” concept), and functions can return a single value or multiple values. For instance, in some cases a CellSript function may spill an entire span of the spreadsheet, outputting a grid of values in the form of TableFrames or CellFrames.

CellScript has a simple type system that is a hybrid of static/dynamic/inferred, and comprises typical value types (numbers, strings, dates, booleans) as well as spreadsheet entities (cells, sheets, workbooks, charts, pivot tables, colors, etc). There are built-in types to deal with the various entities in the workbook, but the type system may otherwise be locked down (e.g., such that users do not create their own classes, etc.). In some cases, a script can declare a variable, and CellScript will infer it being an Int (e.g., myVariable=10). In some cases, a script can declare its type explicitly (e.g., myVariable:Int=10. Names may be reserved for cell references that follow an alpha-number convention. For example, a script can use this to reference a cell and do operations with it, like addition:

myVariable = A1
mySum = myVariable + B1

When a cell is referenced in CellScript, it actually is of type Cell and not just a simple data value. Mathematical operations like the previous example will infer and operate on the numeric value of the cell. But other cell properties can also be manipulated, for example, formatting and metadata. In the following example script, the cell's fill color is changed and a comment is added:

myCell = A1
myCell.fillColor = Color.RED
MyCell.comment = “Input your value here”
// or...
(A1).fillColor = Color.RED
(A1).comment = “Input your value here”

CellScript allows a script to programmatically assign values to cells. Values on cells can be dynamically typed.

(A1) .value = 3
// or...
A1 = 3

CellScript can check the type of the value before using it. The following example script checks whether the cell's value is an INT before adding one to it:

```
if (A1).valueType == ValueType.INT
  A1 += 1
else
  throw Error(“This is not an integer!”)
```

There are multiple modes of organizing cells in CellScript, depending on the structure of what's selected or being created. The table below provides example entities that can used by CellScript; each can be built from scratch and placed into a spreadsheet via a script.

TABLE 1
Example CellScript Entities

| | | | Constructor |
|---|---|---|---|
| Entity | Description | Select Notation | Notation |
| Scalar | A single cell | (A1) | Cell ( ) |
| | with an | | |
| | implicit | | |
| | value | | |
| TableFrame | A strictly | TableFrame | TableFrame ( ) |
| | tabular | (A1:D100) | |
| | range of | | |
| | cells (with | | |
| | headers) | | |
| CellFrame | A freeform | (A1:A100) | CellFrame ( ) |
| | rectangular | | |
| | area of cells | | |
| | with no | | |
| | explicit | | |
| | structure | | |
| Set | A series of | (A1:A100, | Set ( ) |
| | non- | C1:C100, D1) | |
| | contiguous | | |
| | cells and cell | | |
| | ranges | | |
| Matrix | A linear | Matrix (A1:C3) | Matrix ( ) |
| | algebraic | | |
| | matrix that | | |
| | should only | | |
| | consist of | | |
| | numbers | | |
| Pivot | A pivotable | Pivot (A1:D100) | Pivot (myTable) |
| | data | | |
| | structure | | |
| | with | | |
| | crosstab and | | |
| | aggregation | | |
| | abilities | | |

In the example list of CellScript entities shown in Table 1 above, a scalar is a single cell, and can be passed to functions expecting a single value parameter. All three of these variables are scalars:

x = A1
y = 3
z = Math.PI / 2.0

In the example list of CellScript entities shown in Table 1 above, a TableFrame is a robust way to handle a range of cells that resemble a table. A TableFrame includes not just values in rows and columns, but rather cells that will go onto a spreadsheet. This creates some powerful possibilities to create TableFrames that have formatting and metadata prepared before being put into a spreadsheet. The following example TableFrame filters for price less than $5:

TableFrame(A1:D100)
.filter { it[“PRICE”] < 5.0 }

TableFrames can be scripted to format rows, columns, and individual cells with colors, comments, and other metadata. A TableFrame can be created from scratch, and the script can spill it into the surrounding cell's region. For example, the following script creates a table of first names, last names and e-mails and applies color formatting to odd rows:

```
myTable = TableFrame(“FIRST NAME”, “LAST NAME”, “EMAIL”)
myTable.addRow(“James”, “Smith”, “js@exampledomain.com”)
myTable.addRow(“John”, “Morrison”, “jm@exampledomain.com”)
// odd number rows are formatted red
myTable.rows.forEach {
  if (it.rowIndex % 2 == 1)
    it.fillColor = Color.RED
}
// return TableFrame to calling cell
myTable
```

In the example list of CellScript entities shown in Table 1 above, a CellFrame is an arbitrary rectangular arrangement of cells, and does not enforce any particular data structure. The declaration (A1:A100) means the rectangular selection includes the contiguous area from top-left cell A1 to bottom-right cell A100. It does not necessarily represent a table, but rather a more freeform piece of a spreadsheet.

Certain operators (like filter ( ) and sample( )) assume the CellFrame has a tabular nature, but do not account for headers like TableFrame does. For this reason, TableFrame is recommended if the area is indeed a table. Tabular and matrix manipulations can be done using row and column indices rather than headers.

CellFrames can be transformed to a different structure using the reshape ( ) operator. For example, the following example script turns the entire range of cells into a single column:

// stacks the three columns into a single column at the
calling cell
(A1:C100).reshape(cols=1)

A CellFrame can also be abstractly created before it is placed into the spreadsheet. This includes the formatting of cells in advance via scripting functionality before they are placed into a cell range. The example script below takes a TableFrame of transactions from a Transactions sheet and stack the amounts horizontally by date. This entire structure is then projected onto the contiguous region of the calling cell:

```
transactions = [Transactions].(A1).detectTable( )
dates = transactions.select(“DATE”).distinct( ).sorted( )
stackedTransactions = CellFrame( )
stackedTransactions.addRow(“Date, “Amounts->””)
for (dt, rowIndex) in dates.withIndex( ) {
  stackedTransactions[rowIndex + 1,0] = dt
  transactionsForDate = transactions.filter { it[“DATE”]
== dt }.sortedDescending { it[“AMOUNT”] }
  transactionsForDate.withIndex( ).forEach { transaction,
colIndex ->
    stackedTransactions[rowIndex + 1, colIndex + 1] =
transaction[“AMOUNT”]
  }
}
stackedTransactions
```

The example code above produces the following output table:

TABLE 2
Example CellScript Output

| Date | Amounts | | | | |
|---|---|---|---|---|---|
| Jan. 5, 2019 | 150.12 | 132.08 | 92.0 | 43.10 | 10.23 |
| Jan. 6, 2019 | 98.29 | 75.20 | | | |
| Jan. 8, 2019 | 124.93 | 57.23 | 23.11 | | |
| Jan. 9, 2019 | 75.23 | 12.11 | 7.65 | 2.11 | |

CellScript supports basic constructs for conditional expressions in if-else fashion. For example, the following example script uses if-else conditional expression:

```
if ((A1).valueType == ValueType.INT)
  (A1) .value += 1
else
  throw Error(“This is not an INT!”)
```

If there are several conditions that result in different values or actions in CellScript, a when expression may be used. The following example script writes a message in the cell indicated what the value type of A1 is:

```
when ((A1).valueType) {
  ValueType.INT -> “This is an INT”
  ValueType.STRING -> “This is a STRING”
  ValueType.DATE -> “This is a DATE”
  ValueType.DECIMAL -> “This is a DECIMAL”
  ValueType.BOOLEAN -> “This is a BOOLEAN”
}
```

Anything that is logically iterable can be looped through in CellScript. For instance, the following example script goes through each cell in range and makes it blank:

for cell in (A1:A100) {
cell.value = null
}

CellScript can also use the forEach( ) operator to perform an action on each iteration, for example:

(A1:A100).forEach {it.value=null}

Sometimes it can be helpful to declare numeric ranges, which can be iterated to do useful things. The following example script populates 10 cells with the numbers 1 through 10:

```
myNumbers = (1..10)
myCell = A1
for i in myNumbers {
  myCell.value = i
  myCell = myCell.moveDown( )
}
```

CellScript can also use fluent constructs to zip the cells with the numbers, and apply the action with each pairing, for example:

(A1:A10).zipWith(1 . . . 10).forEach {cell,i→cell.value=i}

In some aspects, cells may be treated as the core entity of CellScript, and all of their properties can be manipulated. In some cases, CellScript can manipulate cells beyond just operators values. For example, CellScript may also change various properties of cells. The following example script formats every cell that is on an odd row number as RED:

```
(A1:A100).forEach {
  if (it.rowIndex % 2 == 1)
    it.fillColor = Color.RED
}
```

In some cases, cells that have been used in a CellScript script execution within another cell may trigger a re-run of the script when any of them have changed.

By default, cell references in CellScript may be relative (similar to traditional spreadsheets). This means their reference is relative to the location of the calling cell. For example, dragging down the script A1+B1 to the next cell below it, that cell would then have the script A2+B2. Dragging to the right cell would yield B1+C1, and so on. To fix the references, dollar signs may be used to fix the row and column reference when the cell script is reused. For example, A$1+B$1 will fix the references vertically, $A1+$B1 will fix horizontally, and $A$1+$B$1 will fix both. In some implementations, tooling might assist in auto-fixing certain situations where relative/absolute referencing are more or less likely. For example, TableFrame functionalities like TableFrame(A1:C100) would trigger a default to TableFrame($A$1:$C$100). The reason is that, although TableFrame may use a relative range, typically it would not. The script (A1).detectTable ( ) may trigger a default of ($A$1).detectTable ( ) for the same reason.

In some instances, a user has several sheets of data and want sheets to reference different parts of the workbook. To access data in another sheet, precede the desired cell range with the sheet's name in square brackets [ ]. The following example script gets a TableFrame based off data in another sheet:

TableFrame([Sheet2].(A1:A100))

To access the entire workbook, the command workbook may be used.

Functions can be used in CellScript to reuse logic, operations, and tasks. These functions can be put into a “code tab” in the workbook which holds global functions that cell scripts can call. A function that takes no arguments and performs an action may be declared, for example, as follows:

fun doSomething( ) {
}

The function can perform a series of actions, and/or return value, for example:

fun calculateSomething( ) {
return 1 + 1
}

In some implementations, when a workbook is opened, it is possible to run initializing CellScript code. In some contexts, this may be discouraged as it might be better for the cells to manage getting data, initializing it, and formatting it. In some cases, a spreadsheet application may use the CellScript language by default, and allow users to leverage other languages instead and use their libraries effectively within the workbook.

In some implementations, a workbook can mix several platforms together, for example, such that a workbook uses CellScript, Python, R, and Java. This creates a powerful environment to experiment and interoperate different languages/platforms together, and leverage the best parts of each one. For instance, CellScript may be used to pull and prepare data, then Python may be used to do a machine learning operation and output the result to another range of cells. This polyglot approach may be preferred by some users, but a user may alternatively operate completely in another language like Python.

Various features can be incorporated to improve inter-operation with Python, R, Java, and other coding platforms. Effective bindings may be built for such platforms. In some cases, the binding system works only with standard data types like numbers, dates, and strings. Or a binding system may work with other types of data. In some cases, cell areas and TableFrames may be passed appropriately to the functions as well, which may utilize a specialized library or other resources for each platform.

In some instances, an API may be provided for multiple computing platforms to interact with the workbook itself. Iterating and manipulating workbook elements in Python or Java may utilize a comprehensive API that allows it to do some of the operations described above with respect to the CellScript language. In some scenarios, it might be advantageous to keep third party code from getting entangled with a workbook API, for example, because the code can easily be extracted into a library outside the workbook.

In some implementations, concurrency can be leveraged to speed up computations, but in some cases, a spreadsheet program manages concurrency and does not allow callbacks created by third party code. For example, if Python or Java were to go rogue and do their own concurrency operations, they may need to block until the needed result is returned. In some cases, a spreadsheet application can show cells that are being computed on a separate thread as “being busy”, so the user is aware a computation is happening and the workbook will update soon. In some cases, third party platforms can create callbacks, for instance Java, can provide a Callback operation to a cell. This may include the plugin knowing how to handle callbacks as well as signal a busy status. It may be simpler for the spreadsheet application and its plugins to manage concurrency and callback operations in some cases.

In some implementations, when a user want to share their Python or Java-enabled workbook, those they want to share with can use their own environments set up appropriately (and with any required libraries). This can be automated or streamlined to make the workbook more portable. Virtual environments and build systems such as Gradle may be useful in such contexts.

In a general aspect, computer code stored in a spreadsheet document can interact with the contents of the cells in the spreadsheet document. For example, the computer code may obtain input data from one or more of the cells, store output data in one or more of the cells, or both.

In a first example, by operation of a spreadsheet application, computer program script stored in a cell of an electronic spreadsheet document is detected. A computer resource to execute the computer program script is identified based on a computer programming language of the computer program script. The computer resource is invoked to execute the computer program script. Output data are generated by the computer resource executing the computer program script. The output data are received and converted to cell values for the electronic spreadsheet document. By operation of the spreadsheet application, the cell values are populated into one or more cells of the electronic spreadsheet document.

Implementations of the first example may include one or more of the following features. The computer program script may be identified by operation of the spreadsheet application running on a computer system; the computer program script may be executed by the computer resource running on the computer system; and the output data may be converted to cell values by a binding engine running on the computer system.

Implementations of the first example may include one or more of the following features. The computer program script may include computer program script written in a JVM language (e.g., Kotlin, Scala, Groovy, Clojure, etc.), and identifying the computer resource may include identifying a Java Virtual Machine to execute the computer program script. The computer program script may include computer program script written in Python, and identifying the computer resource may include identifying a Python implementation to execute the computer program script. The computer program script may include computer program script written for any programming platform in general, and the appropriate computer resource may be identified based on the programming platform for which the computer program script is written.

Implementations of the first example may include one or more of the following features. Converting the output data to cell values may include generating a tabular structure based on the output data. Populating the cell values into one or more cells of the electronic spreadsheet document may include storing the tabular structure in the one or more cells of the electronic spreadsheet document. The computer program script may include multi-line operations, function calls, or a combination of these and other types of script elements.

Implementations of the first example may include one or more of the following features. The computer resource may include a compiler that compiles the computer program script (e.g., Java, or another type of compiled code) for execution by the computer resource. The computer resource may include an interpreter that interprets the computer program script (e.g., Python, or another type of interpreted code) for execution by the computer resource.

Implementations of the first example may include one or more of the following features. Input data may be obtained based on the computer program script. The input data may be provided to the computer resource for use in executing the computer program script. The input data may include one or more cell values, and obtaining the input data may include detecting a cell reference in the computer program script; and obtaining the cell value from the electronic spreadsheet document based on the cell reference. The input data may include one or more global resources, and obtaining the input data may include detecting, in the computer program script, a reference to the one or more global resources; and obtaining the one or more global resources.

Implementations of the first example may include one or more of the following features. By operation of the spreadsheet application, the electronic spreadsheet document comprising the cell values populated in the one or more cells may be rendered. The rendered document may be displayed on a display device.

In a second example, a non-transitory computer-readable medium stores instructions that are operable when executed by data processing apparatus to perform one or more operations of the first example. In a third example, a system includes one or more processors and memory storing instructions that are operable, when executed by the one or more processors, to perform one or more operations of the first example.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

What is claimed is:

1. A method comprising:
by operation of a spreadsheet application, detecting computer program script stored in a cell of an electronic spreadsheet document;
identifying a computer resource to execute the computer program script based on a computer programming language of the computer program script;
invoking the computer resource to execute the computer program script;
receiving output data generated by the computer resource executing the computer program script;
converting the output data to cell values for the electronic spreadsheet document; and
by operation of the spreadsheet application, populating the cell values into one or more cells of the electronic spreadsheet document.

2. The method of claim 1, wherein the computer program script is identified by operation of the spreadsheet application running on a computer system, the computer program script is executed by the computer resource running on the computer system, and the output data are converted to cell values by a binding engine running on the computer system.

3. The method of claim 1, wherein the computer program script comprises computer program script written in a JVM language, and identifying the computer resource comprises identifying a Java Virtual Machine to execute the computer program script.

4. The method of claim 1, wherein the computer program script comprises computer program script written in Python, and identifying the computer resource comprises identifying a Python implementation to execute the computer program script.

5. The method of claim 1, wherein converting the output data to cell values comprises generating a tabular structure based on the output data, and wherein populating the cell values into one or more cells of the electronic spreadsheet document comprises storing the tabular structure in the one or more cells of the electronic spreadsheet document.

6. The method of claim 1, wherein the computer resource comprises a compiler that compiles the computer program script for execution by the computer resource.

7. The method of claim 1, wherein the computer resource comprises an interpreter that interprets the computer program script for execution by the computer resource.

8. The method of claim 1, wherein the computer program script includes at least one of a multi-line operation or a function call.

9. The method of claim 1, comprising:
obtaining input data based on the computer program script; and
providing the input data to the computer resource for use in executing the computer program script.

10. The method of claim 9, wherein the input data comprises one or more cell values, and obtaining the input data comprises:
detecting a cell reference in the computer program script; and
obtaining the cell value from the electronic spreadsheet document based on the cell reference.

11. The method of claim 9, wherein the input data comprises one or more global resources, and obtaining the input data comprises:
detecting, in the computer program script, a reference to the one or more global resources; and
obtaining the one or more global resources.

12. The method of claim 1, further comprising, by operation of the spreadsheet application, rendering the electronic spreadsheet document comprising the cell values populated in the one or more cells.

13. A non-transitory computer-readable medium storing instructions that are operable when executed by data processing apparatus to perform operations comprising:
by operation of a spreadsheet application, detecting computer program script stored in a cell of an electronic spreadsheet document;
identifying a computer resource to execute the computer program script based on a computer programming language of the computer program script;
invoking the computer resource to execute the computer program script;
receiving output data generated by the computer resource executing the computer program script;
converting the output data to cell values for the electronic spreadsheet document; and
by operation of the spreadsheet application, populating the cell values into one or more cells of the electronic spreadsheet document.

14. The non-transitory computer-readable medium of claim 13, wherein converting the output data to cell values comprises generating a tabular structure based on the output data, and wherein populating the cell values into one or more cells of the electronic spreadsheet document comprises storing the tabular structure in the one or more cells of the electronic spreadsheet document.

15. A computer system comprising:
one or more processors; and
memory storing instructions that are operable when executed by the one or more processors to perform operations comprising:
by operation of a spreadsheet application running on the computer system, detecting computer program script stored in a cell of an electronic spreadsheet document;
identifying a computer resource to execute the computer program script based on a computer programming language of the computer program script;
invoking the computer resource to execute the computer program script;
receiving output data generated by the computer resource running on the computer system to execute the computer program script;
converting the output data to cell values for the electronic spreadsheet document; and
by operation of the spreadsheet application running on the computer system, populating the cell values into one or more cells of the electronic spreadsheet document.

16. The computer system of claim 15, wherein the computer program script comprises computer program script written in a JVM language, and identifying the computer resource comprises identifying a Java Virtual Machine to execute the computer program script.

17. The computer system of claim 15, wherein the computer program script comprises computer program script written in Python, and identifying the computer resource comprises identifying a Python implementation to execute the computer program script.

18. The computer system of claim 15, the operations comprising:
obtaining input data based on the computer program script; and
providing the input data to the computer resource for use in executing the computer program script.

19. The computer system of claim 18, wherein the input data comprises at least one of:
one or more cell values obtained from the electronic spreadsheet document; or
one or more global resources.

20. The computer system of claim 15, further comprising a display device, wherein the operations comprise:
rendering the electronic spreadsheet document comprising the cell values populated in the one or more cells; and
displaying the rendered the electronic spreadsheet document on the display device.
